(19) United States
(12) Patent Application Publication
(10) Pub. No.: US 2018/0186048 A1
(43) Pub. Date: Jul. 5, 2018

(54) METHOD FOR PRODUCING A MULTI-COMPONENT INJECTION-MOLDED PART

(71) Applicant: HELLA GmbH & Co. KGaA, Lippstadt (DE)

(72) Inventors: Odo KARGER, Geseke (DE); Ulrich TEMME, Lippstadt (DE)

(73) Assignee: HELLA GmbH & Co. KGaA, Lippstadt (DE)

(21) Appl. No.: 15/907,765

(22) Filed: Feb. 28, 2018

Related U.S. Application Data
(63) Continuation of application No. PCT/EP2016/068307, filed on Aug. 1, 2016.

(30) Foreign Application Priority Data
Aug. 28, 2015 (DE) 10 2015 114369.0

(51) Int. Cl. B29C 45/16; B29C 65/10; B29C 65/16; B29C 65/00; B60Q 1/30

(52) U.S. Cl. CPC B29C 45/1657; B29C 65/106; B29C 65/1654; B29C 66/1142; B29C 66/71; B29L 2031/747; B29C 66/91411; B29C 66/919; B29C 66/939; B60Q 1/30; B29C 2045/1659; B29C 66/836

(57) ABSTRACT

A method for manufacturing a multicomponent injection-molded part is provided. A first plastic component is manufactured with the aid of a first injection molding step, and a second plastic component is at least partially injection-molded onto or over the first plastic component with the aid of a second injection molding step, so that a material composite is formed with the two plastic components. At least one part of an edge area along the parting line between the two plastic components is heated by means of a heat source for the purpose of sealing the two plastic components to each other in the edge area.

This nonprovisional application is a continuation of International Application No. PCT/EP2016/068307, which was filed on Aug. 1, 2016, and which claims priority to German Patent Application No. 10 2015 114 369.0, which was filed in Germany on Aug. 28, 2015, and which are both herein incorporated by reference.

### BACKGROUND OF THE INVENTION

### Field of the Invention

The present invention relates to a method for manufacturing a multicomponent injection-molded part, a first plastic component being manufactured with the aid of a first injection molding step, and a second plastic component being at least partially injection-molded onto or over the first plastic component with the aid of a second injection molding step, so that a material composite is formed with the two plastic components.

### Description of the Background Art

DE 10 2005 038 932 A1 describes a method for manufacturing a multicomponent injection-molded part, and a first plastic component is manufactured with the aid of a first injection molding step, and a second plastic component is at least partially injection-molded onto or over the first plastic component with the aid of a second injection molding step. A material composite is thus formed with the two plastic components.

A method for manufacturing a multicomponent injection-molded part is also used in the manufacture of outer panes or cover panes for tail lamps for motor vehicles. For example, DE 199 41 524 A1 shows a tail light for a vehicle, which includes a lens, and colored plastic components are inserted to produce different light colors, for example a red brake light and a yellow blinker.

If a multicomponent injection molding method is used to manufacture a lens of a lighting device of a vehicle, as is customary today, in particular to manufacture a cover pane of a tail light, a first plastic component is first manufactured continuously, which spans the entire cover surface of the tail lamp, and one or multiple second plastic components are injection-molded thereon in a locally delimited manner, the method also being carried out in reverse order, and the locally formed plastic bodies are injection-molded, and the plastic component spanning the entire cover surface of the tail lamp and the individual plastic bodies is injection-molded thereafter. Under certain circumstances, damage forms over the edge area, along the parting line between the two plastic components.

FIG. 4 shows an example of a crack 18, which forms in edge area 12 between the two plastic components 10 and 11, as can be observed in existing plastic composites. In addition, a gap 17 forms in the edge area, so that contamination, discoloration and the like may result, which are always to be avoided in the injection-molded part, and a gap 17 of this type frequently forms a starting point for the formation of crack 18.

FIG. 5 shows a notch 19 formed in edge area 12 between the two plastic components 10 and 11, which is also to be avoided.

In manufacturing the multicomponent injection-molded parts, the two plastic components 10 and 11 form a parting line 13, which separates the components. The formation of gaps 17, cracks 18 or notches 19 in edge area 12 along parting line 13 is caused by climactic influences, in particular changing humidity and changing temperatures as well as, for example, in combination with the influence of media such as alcohols and the like. Such patterns of damage are unacceptable, due to the decorative appearance that vehicle tail lights also provide.

### SUMMARY OF THE INVENTION

It is therefore an object of the present invention to provide a method for manufacturing a multicomponent injection-molded part, in which the damage described above no longer occurs. In particular, the object of the invention is to refine a method for manufacturing a multicomponent injection-molded part in such a way that gaps, cracks or notches in the edge area on the parting line between the two plastic components do not occur.

The invention covers the technical teaching that at least one part of an edge area along the parting line between the two plastic components is heated by means of a heat source to seal the two plastic components to each other in the edge area.

Thus, a heat treatment of the edge area is provided along the parting line following the injection molding, to achieve a sealing of the two plastic components. A sealing of the two plastic components can be understood in the present case to be a closing of a gap between the two plastic components, this gap being able to be only a few μm, and enlarging over the course of the operation of the material composite and only thereby becoming visible.

As a result of the sealing, a notch-free, gap-free transition from the surface of the first plastic component to the surface of the second plastic component is produced, and the integral fit between the two plastic components extends to the outer surface of the two plastic components.

It has proven to be particularly advantageous if the heating of the plastic components is carried out beyond the melting temperature of the plastic components. For example, the plastic components each include a PMMA plastic, and the edge area of the plastic components is advantageously heated to a temperature above 300° C., for example up to 450° C., preferably to a temperature between 330° C. and 370° C., and particularly preferably to a temperature of 350° C. The heating temperature is thus above the melting temperature of the plastic components, so that a soft transition groove may form in the edge area between the two plastic components.

The method according to the invention may be carried out using different heat sources. For example, an acetylene gas flame, a hydrogen gas flame, a propane/butane gas flame, a micro-plasma or a laser beam source may be used as the heat source.

The heating process may take place by exposure to flames or by a plasma or laser irradiation in such a way that the heat source is guided along the parting line between the two plastic components. The heat source may be guided along the parting line, for example at a feed rate of 30 mm per second to 60 mm per second, preferably 45 mm per second.

If a heat source having a hydrogen gas flame is used, a nozzle having a diameter of, for example, 0.6 mm to 1.2 mm and preferably 0.8 mm may be used, and a nozzle distance from the surface of the edge area of between 2 mm and 5 mm and preferably of 4 mm may be provided.

Particularly advantageous results have been shown when the gas pressure of the hydrogen or the hydrogen/oxygen mixture is 65 mbar. The exposure to flames may take place cycle-neutrally, in parallel to the injection molding process, for example in a separate robot cell. This achieves the advantage that the cycle time is not additionally prolonged, for example if the injection molding and flame exposure take place synchronously when manufacturing a large number of injection-molded parts.

The invention is furthermore directed to a multicomponent injection-molded part, which is manufactured using the method. At least one part of an edge area along the parting line between the two plastic components has a heat impact zone. The multicomponent injection-molded part particularly advantageously forms the lens of a lighting device of a vehicle.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of two plastic components, which are injection-molded onto each other in the multicomponent injection-molding method, an edge area between the two plastic components forming Detail Z;

FIG. 2 shows a schematic view of Detail Z according to FIG. 1;

FIG. 3 shows a view of the edge area of the two plastic components, including a transition groove enclosed in the edge area by way of the embodiment of the method according to the invention;

FIG. 4 shows a prior-art edge area of an edge area between two plastic components, having a pattern of damage in the form of a crack; and

FIG. 5 shows a prior-art edge area between two plastic components, including a notch, which is to be avoided as a weak point and source of damage of a crack.

### DETAILED DESCRIPTION

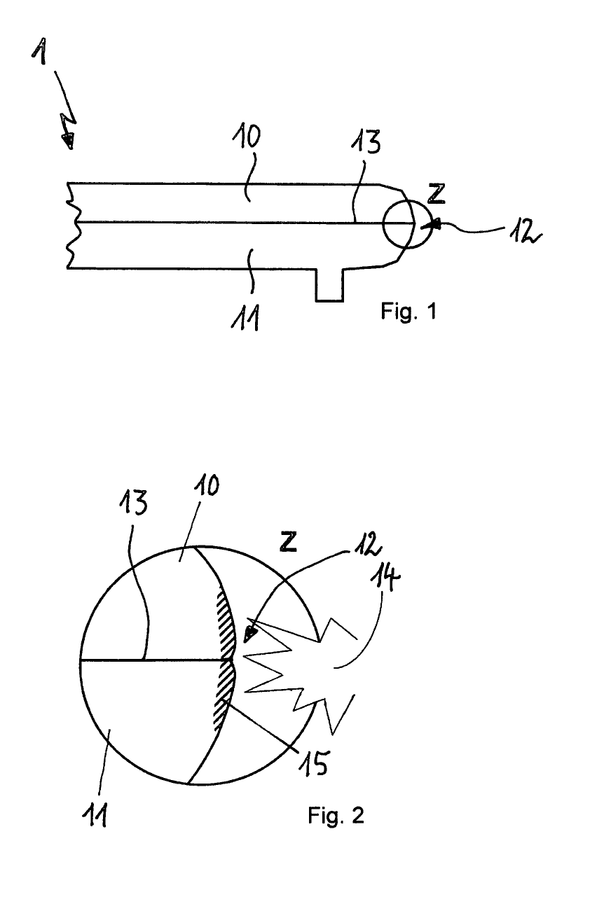

FIG. 1 shows a partial, schematic view of a multicomponent injection-molded part 1, which includes a first plastic component 10 and a second plastic component 11. The two plastic components 10 and 11 are manufactured by means of the multicomponent injection molding method, in that first plastic component 10 is manufactured with the aid of a first injection molding step, second plastic component 10 being injection molded onto first plastic component 11. The illustrated material composite is thus formed, which may form, for example, the lens of a tail lamp of a vehicle. For example, first plastic component 10 is provided with a continuous design and spans the entire tail lamp. Component 11 may be, for example, a locally delimited, colored component, for example for forming a red brake light or a yellow blinker.

A parting line 13 forms between the two plastic components 10 and 11 in edge area 12, which is provided, for example, with a circumferential design and completely surrounds plastic components 10 and 11. Plastic components 10 and 11 do not both have to terminate in edge area 12, and it is likewise possible for one plastic component 10 or 11 to project over other plastic component 10, 11. Detail Z in edge area 12 illustrated in an enlargement in FIG. 2.

FIG. 2 shows an enlarged representation of Detail Z in edge area 12 between the two plastic components 10 and 11. A heat source 14 is furthermore shown schematically, which acts very briefly upon edge area 12 and heats it. For example, heat source 14 is moved along parting line 13 to carry out the method, so that a heat impact zone 15 forms over the length of parting line 13.

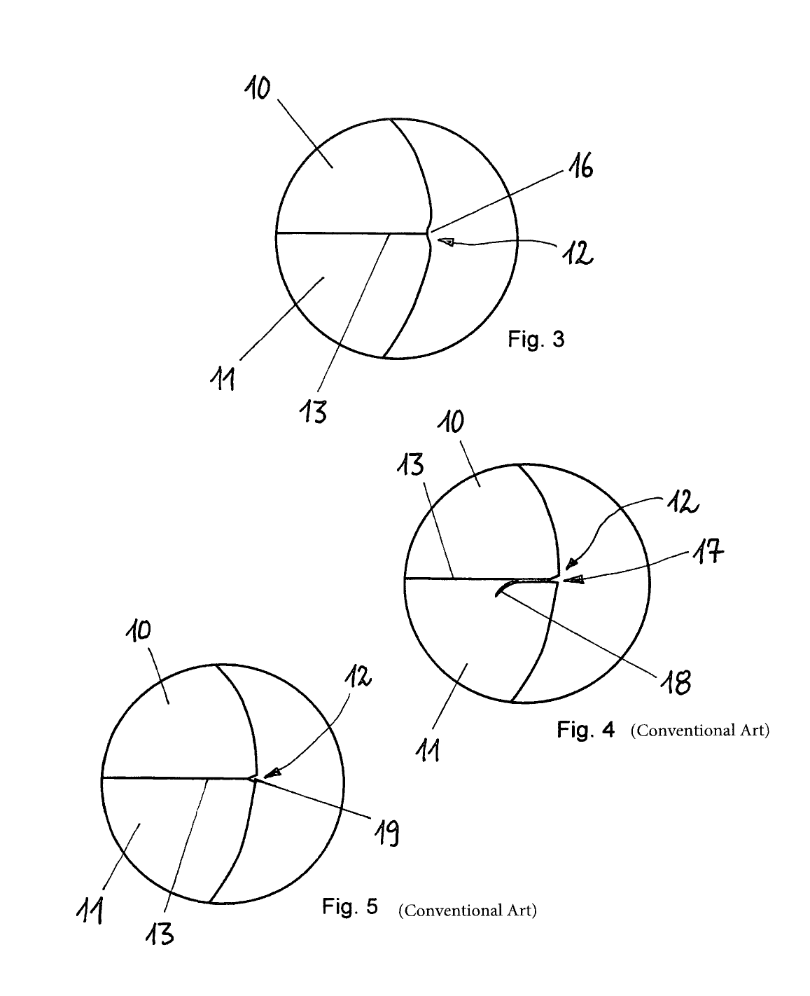

FIG. 3 shows a treated heat area 12 after a heat influence, and a groove 16 forms along parting line 13 in edge area 12 due to the brief heating of edge area 12. Groove 16 forms as a result of a sealing action, in that plastic components 10 and 11 were briefly heated above the melting temperature, for example to 350° C. Due to the brief melting on of the plastic components, which takes place only in edge area 12, a common melt of the two plastic components 10 and 11 may form, which, however, does not necessarily have to include a mixing.

FIGS. 4 and 5 show a prior art, including damage in edge area 12 along parting line 13 between the two plastic components 10 and 11. FIG. 4 shows a crack 18, which migrates in the direction of a gap 17 formed between the two plastic components 10 and 11. FIG. 5 shows a notch 19 in edge area 12 along parting line 13 between the two plastic components 10 and 11, which may occur as a result of the process, and a source of damage emerges to form gap 17. The damage may form as a result of climactic influences, in particular due to changing humidity and changing temperatures as well as media influences.

Both patterns of damage according to FIG. 4 and FIG. 5 may be avoided with the aid of the method according to the invention, in that, as shown in FIG. 3, a soft transition groove 16 is formed as a crack-free, gap-free transition between the surface of first plastic component 10 and the surface of second plastic component 11, due to the heating by means of heat source 14.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for manufacturing a multicomponent injection-molded part, the method comprising:
manufacturing a first plastic component by a first injection molding step;
partially injection-molding a second plastic component onto or over the first plastic component via a second injection molding step, so that a material composite is formed with the two plastic components; and
heating at least one part of an edge area along a parting line between the first and second plastic components via a heat source to seal the first and the second plastic components to each other in the edge area.

2. The method according to claim 1, wherein the first and second plastic components are heated above a melting temperature of the first and second plastic components.

3. The method according to claim 1, wherein the first and second plastic components each include a PMMA plastic and are heated to a temperature above 300° C., preferably to 330° C. to 370° C. and particularly preferably to 350° C.

4. The method according to claim 1, wherein an acetylene gas flame, a hydrogen gas flame, a butane gas flame, a micro-plasma or a laser beam source is used as the heat source.

5. The method according to claim 1, wherein the heat source is guided along the parting line between the first and second plastic components.

6. The method according to claim 5, wherein the feed rate of the heat source along the parting line is 30 mm/s to 60 mm/s, preferably 45 mm/s.

7. The method according to claim 1, wherein a distance of a gas nozzle of the heat source from the edge area to be heated is 3 mm to 5 mm and preferably 4 mm.

8. The method according to claim 1, wherein the edge area is heated in a cycle time-neutral manner during an injection molding process or between two injection molding processes.

9. A multicomponent injection-molded part manufactured according to the method according to claim 1, wherein at least one part of an edge area along the parting line between the first and second plastic components has a heat impact zone.

10. The multicomponent injection-molded part according to claim 9, wherein the multicomponent injection-molded part is a lens of a lighting device of a vehicle.
